(19) United States
(12) Patent Application Publication
(10) Pub. No.: US 2013/0335987 A1
(43) Pub. Date: Dec. 19, 2013

(54) TRAILER LIGHT EXTENSION

(71) Applicant: Polly Trotter, Rogers, AR (US)

(72) Inventor: Polly Trotter, Rogers, AR (US)

(21) Appl. No.: 13/495,515

(22) Filed: Jun. 13, 2012

(51) Int. Cl. B60Q 1/44

(52) U.S. Cl. 362/485

(57) ABSTRACT

The present invention is a trailer light extension that includes a light, a mounting plate placed underneath the light, a telescoping vertical stem that includes a bottom and a top, the light and the mounting plate is mounted on the top of the telescoping vertical stem and a wiring connector provides power to the light. A locking pin is inserted into first corresponding plurality of apertures at one of a plurality of predetermined heights, a telescoping receiving arm is perpendicularly attached to the bottom of the telescoping vertical stem and a clamp with an extended horizontal portion, an upright u-shaped clamp and a securing knob, the clamp secures the trailer light extension to a vehicle.

### TECHNICAL FIELD & BACKGROUND

On the highways and roadways some trucks have a low running trailer connected on a hitch to expand the carrying capacity for the device. If a trailer is empty, it can be difficult for other drivers to see it which can lead to accidents on the road.

The present invention generally relates to a light extension. More specifically, the invention is a trailer light extension.

It is an object of the invention to provide a trailer light extension that is relatively easily clamped down onto a flatbed portion of a trailer.

It is an object of the invention to provide a trailer light extension that increases visibility, safety and complies with DOT standards.

It is an object of the invention to provide a trailer light extension that can be utilized on a relatively small trailer or a relatively large commercial trailer.

What is really needed is a trailer light extension that is relatively easily clamped down onto a flatbed portion of a trailer that increases visibility, safety and complies with DOT standards that can be utilized on a relatively small trailer or a relatively large commercial trailer.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of a trailer light extension, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

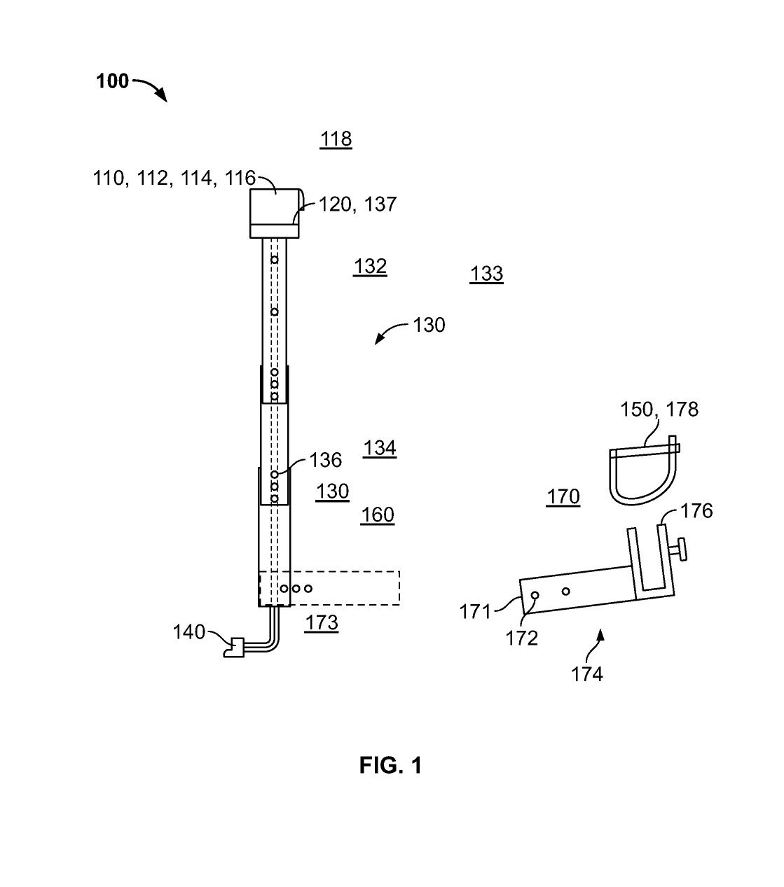

FIG. 1 illustrates a side view of a trailer light extension 100, according to an embodiment of the present invention. The trailer light extension 100 can be clamped down onto a flatbed portion of a trailer to relatively increase visibility, safety and complies with DOT standards and can be utilized on a relatively small trailer or a relatively large commercial trailer.

The trailer light extension 100 includes a light 110, a mounting plate 120, a telescoping vertical stem 130, a wiring connector 140, a locking pin 150, a telescoping receiving arm 160 and a clamp 170.

The light 110 can be a brake light 112, a turn signal light 114, a back-up light 116 or other suitable light. The light 110 also has an auxiliary light 118 that can be utilized if the brake light 112, the turn signal light 114 or the back-up light 116 is inoperable. The mounting plate 120 is placed underneath the light 110 and mounts the light 110 to the trailer light extension 100. The telescoping vertical stem 130 includes a bottom 131 and a top 137 where the mounting plate 120 mounts the light 110. The telescoping vertical stem 130 also includes a top telescoping portion 132 and a bottom telescoping portion 134 where the top telescoping portion 132 is inserted into the bottom telescoping portion 134 and is vertically moved and adjusted within the relatively larger diameter bottom telescoping portion 134. The top telescoping portion 132 and the bottom telescoping portion 134 have a first plurality of apertures 133 that can be moved into position to form a first corresponding plurality of apertures 136 formed from the first plurality of apertures 133 on the top telescoping portion 132 aligned with the first plurality of apertures 133 on the bottom telescoping portion 134. The movement of the first plurality of apertures 133 on the top telescoping portion 132 aligned with the first plurality of apertures 133 on the bottom telescoping portion 134 controls the height of the light 110. The first corresponding plurality of apertures 136 control the height of the light 110 at a plurality of predetermined heights determined by the first corresponding plurality of apertures 136. The height of the light 110 is adjustably in the range of approximately 1 foot, 4 inches to 4 feet in height, although the height of the light 110 can be any suitable height. The wiring connector 140 provides power to the light 110 and the auxiliary light 118 typically from a power source such as a battery from a truck or other vehicle the trailer light extension 100 is attached to. The locking pin 150 is inserted into the first corresponding plurality of apertures 136 at the desired one of the plurality of predetermined heights determined by the first corresponding plurality of apertures 136.

The telescoping receiving arm 160 is perpendicularly attached to the bottom 131 of the telescoping vertical stem 130 and extends horizontally from the telescoping vertical stem 130. The clamp 170 includes an extended horizontal portion 172, an upright u-shaped clamp 174 and a securing knob 176. The extended horizontal portion 172 is inserted into the telescoping receiving arm 160 and is horizontally moved and adjusted within the relatively larger diameter telescoping receiving arm 160. The extended horizontal portion 172 and the telescoping receiving arm 160 have a second plurality of apertures 171 that can be moved into position to form a second corresponding plurality of apertures 173 formed from the second plurality of apertures 171 on the extended horizontal portion 172 aligned with the second plurality of apertures 173 on the telescoping receiving arm 160. The second corresponding plurality of apertures 173 control the length that the clamp 170 can be extended at a plurality of predetermined lengths determined by the second corresponding plurality of apertures 173. The extended horizontal portion 172 extends horizontally in the range of approximately 4 inches to 1 foot 4 inches or any other suitable length. An additional locking pin 178 is inserted into the second corresponding plurality of apertures 136 at the desired one of the plurality of predetermined lengths determined by the second corresponding plurality of apertures 173. The upright u-shaped clamp 174 and the securing knob 176 can receive and removably secure a portion of the vehicle or trailer attached to the trailer light extension 100. The telescoping receiving arm 160 can also be welded to a portion of the vehicle or trailer attached to the trailer light extension 100.

The trailer light extension provides visibility to low lying vehicle accessories. The trailer light extension has a telescoping pole with one or more marker lights disposed on its top that is relatively quickly and easily spotted while on the road. The lights are adjustable in height in the range of approximately 1 foot, 4 inches to 4 feet and have an extension arm that extends in the range of approximately 4 inches to 1 foot 4 inches and can be attached with a suitable clamp or welded onto a new trailer model. Trailer drivers are among the many people who may find the trailer light extensions both convenient and easy to use. The trailer light extension features an adjustable illumination system for automotive hauling equipment. The trailer light extension is designed with the ability to accommodate running lights, turn signals, brake lights and back-up lights.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A trailer light extension, comprising:
a light;
a mounting plate placed underneath said light and mounts said light to said trailer light extension;
a telescoping vertical stem that includes a bottom and a top, said light and said mounting plate is mounted on said top of said telescoping vertical stem, said telescoping vertical stem includes a top telescoping portion and a bottom telescoping portion, said top telescoping portion is inserted into said bottom telescoping portion and is vertically moved and adjusted within said bottom telescoping portion, said top telescoping portion and said bottom telescoping portion have a first plurality of apertures, said first plurality of apertures are moved into position to form a first corresponding plurality of apertures, said first corresponding plurality of apertures are formed from said first plurality of apertures on said top telescoping portion aligned with said first plurality of apertures on said bottom telescoping portion;
a wiring connector provides power to said light;
a locking pin inserted into said first corresponding plurality of apertures at one of said plurality of predetermined heights;
a telescoping receiving arm perpendicularly attached to said bottom of said telescoping vertical stem, said telescoping receiving arm extends horizontally from said telescoping vertical stem, said extended horizontal portion is inserted into said telescoping receiving arm and is horizontally moved and adjusted within said telescoping receiving arm, said extended horizontal portion and said telescoping receiving arm have a second plurality of apertures that are moved and aligned into position to form a second corresponding plurality of apertures; and
a clamp with an extended horizontal portion, an upright u-shaped clamp and a securing knob, said clamp secures said trailer light extension to a vehicle.

2. The trailer light extension according to claim 1, wherein said light includes an auxiliary light that is utilized if said light is inoperable.

3. The trailer light extension according to claim 1, wherein said light is a brake light.

4. The trailer light extension according to claim 1, wherein said light is a turn signal light.

5. The trailer light extension according to claim 1, wherein said light is a back-up light.

6. The trailer light extension according to claim 1, wherein said first corresponding plurality of apertures control a plurality of predetermined heights of said light.

7. The trailer light extension according to claim 1, wherein said power is from said vehicle battery said trailer light extension is attached to.

8. The trailer light extension according to claim 1, wherein said second corresponding plurality of apertures control a plurality of predetermined lengths that said clamp is extended.

9. The trailer light extension according to claim 8, wherein said clamp includes an additional locking pin that is inserted into said second corresponding plurality of apertures at said plurality of predetermined lengths determined by said second corresponding plurality of apertures.

10. The trailer light extension according to claim 1, wherein said upright u-shaped clamp and said securing knob receive and removably secure a portion of said vehicle to said trailer light extension.

11. A trailer light extension, comprising:
a light, said light includes an auxiliary light that is utilized if said light is inoperable;
a mounting plate placed underneath said light and mounts said light to said trailer light extension;
a telescoping vertical stem that includes a bottom and a top, said light and said mounting plate is mounted on said top of said telescoping vertical stem, said telescoping vertical stem includes a top telescoping portion and a bottom telescoping portion, said top telescoping portion is inserted into said bottom telescoping portion and is vertically moved and adjusted within said bottom telescoping portion, said top telescoping portion and said bottom telescoping portion have a first plurality of apertures, said first plurality of apertures are moved into position to form a first corresponding plurality of apertures, said first corresponding plurality of apertures are formed from said first plurality of apertures on said top telescoping portion aligned with said first plurality of apertures on said bottom telescoping portion, said first corresponding plurality of apertures control a plurality of predetermined heights of said light;
a wiring connector provides power to said light;
a locking pin inserted into said first corresponding plurality of apertures at one of said plurality of predetermined heights;
a telescoping receiving arm perpendicularly attached to said bottom of said telescoping vertical stem, said telescoping receiving arm extends horizontally from said telescoping vertical stem, said extended horizontal portion is inserted into said telescoping receiving arm and is horizontally moved and adjusted within said telescoping receiving arm, said extended horizontal portion and said telescoping receiving arm have a second plurality of apertures that are moved and aligned into position to form a second corresponding plurality of apertures; and
a clamp with an extended horizontal portion, an upright u-shaped clamp and a securing knob, said upright u-shaped clamp and said securing knob receive and removably secure a vehicle to said trailer light extension.

12. The trailer light extension according to claim 11, wherein said light is a brake light.

13. The trailer light extension according to claim 11, wherein said light is a turn signal light.

14. The trailer light extension according to claim 11, wherein said light is a back-up light.

15. The trailer light extension according to claim 11, wherein said plurality of predetermined heights of said light is adjustably in the range of approximately 1 foot, 4 inches to 4 feet in height.

16. The trailer light extension according to claim 11, wherein said power is from said vehicle battery said trailer light extension is attached to.

17. The trailer light extension according to claim 11, wherein said second corresponding plurality of apertures control said plurality of predetermined lengths that said clamp is extended.

18. The trailer light extension according to claim 11, wherein said clamp includes an additional locking pin that is inserted into said second corresponding plurality of apertures at said plurality of predetermined lengths.

19. The trailer light extension according to claim 11, wherein said extended horizontal portion extends horizontally in the range of approximately 4 inches to 1 foot 4 inches.

20. The trailer light extension according to claim 11, wherein said telescoping receiving arm is welded to said portion of said vehicle.
